(19) United States
(12) Patent Application Publication
(10) Pub. No.: US 2006/0211780 A1
(43) Pub. Date: Sep. 21, 2006

(54) Method and apparatus for the continuous manufacture of expandable plastic granulate

(76) Inventors: Claude Passaplan, Winterthur (CH); Herbert Scherrer, Uster (CH)

Correspondence Address: Francis C. Hand, Esq.;c/o Carella, Byrne, Bain, Gilfillan, Cecchi,, Stewart & Olstein, 5 Becker Farm Road, Roseland, NJ, 07068, US

(21) Appl. No.: 11/367,730

(22) Filed: Mar. 3, 2006

(30) Foreign Application Priority Data
Mar. 17, 2005 (EP) 05405249.3

(51) Int. Cl. C08J 9/18

(52) U.S. Cl. 521/60

(57) ABSTRACT

Expandable plastic granulate can be manufactured continuously with a plastic melt being impregnated using a fluid expanding agent and the impregnated melt being granulated. The plant which includes at least one pressure producing feed apparatus for the melt, a metering apparatus for the expanding agent, contacting and homogenising apparatus for the impregnation of the melt, at least one cooler for the impregnated melt, an underwater granulator and a plant control. An elevated pressure is exerted by the liquid used during granulation to suppress the expanding action of the expanding agent in the not yet solidified granulate. A regulation of the temperature and pressure of the impregnated melt is effected at the inlet of the granulator to influence a heat take-up from the impregnated melt by the cooler or coolers.

This invention relates to a method and apparatus for the continuous manufacture of expandable plastic granulate.

A method and a plant for the manufacture of expandable plastic granulate is known from EP-A-0 668 139. In a special embodiment of the method, an impregnated polymer melt is extruded through nozzles to form individual strands that are then quenched with water to be solidified and brought into granulate form in a granulator by comminution with rotating knives. Typically, the strands are comminuted while under water.

In this method, the polymer melt is pre-cooled prior to entry into the granulator in order to avoid expansion of the strands during extrusion. The provision made for cooling of the impregnated melt to a temperature which lies a few degrees C above the solidification temperature of the melt is problematic. This is because it is very difficult under circumstances, such as these, to allow the same quantity of melt to flow through all the extrusion nozzles of the granulator that are arranged in parallel. Instabilities in the melt flow can arise which, in turn, can lead to the clogging of individual nozzles due to the melt solidifying in them.

Accordingly, it is an object of the invention to avoid clogging of the nozzles of a granulator for comminuting the strands of a polymer melt.

It is another object of the invention to improve the apparatus for the continuous manufacture of expandable plastic granulate.

Briefly, the invention provides a plant for the continuous manufacture of expandable plastic granulate that comprises first means for supplying a flow of polymer melt; second means for impregnating the flow of polymer melt with an expanding agent; a homogenizing apparatus including at least one static mixer for homogenizing the expanding agent within the polymer melt to form a homogeneous mass and a cooler downstream of the homogenizing apparatus to receive and cool the homogeneous mass.

In addition, the plant comprises a granulator downstream of the cooler to receive the cooled homogeneous mass. This granulator has a plurality of nozzles for passage of the homogeneous mass therethrough to form a plurality of strands of the homogeneous mass, a comminuting device for comminuting the plurality of strands into granules and a chamber for receiving the granules and a flow of coolant for cooling the granules.

Further, the plant comprises an electronic plant control operatively connected to each of the first means, the second means, the cooler and the granulator to maintain the pressure and temperature of the homogeneous mass received in the granulator in a predetermined range to prevent solidification of the homogeneous mass and to prevent clogging of the nozzles.

Moreover, a more flexible alternative should be found which can be applied more universally, with a combination of two static mixers in which the melt is initially treated with a large shearing action and subsequently with a reduced shearing action in particular no longer being necessary, but can, however, still be an advantageous variant.

Using the method, expandable plastic granulate can be manufactured continuously, with a plastic melt being impregnated using a fluid expanding agent and the impregnated melt being granulated

The granulation is carried out using a liquid which is used in the granulator as a cooling and transport medium for the granulate. The liquid is, in particular, water or a brine (or a sols). An elevated pressure is applied with the liquid used during granulation, due to which an expanding action of the expanding agent in the not yet solidified granulate is at least partly suppressed.

A regulation of the parameters to be adjusted for the granulation, namely the temperature and pressure of the impregnated melt is effected at the inlet of the granulator. In this regulation, measurements of the named parameters are made and also measurement values are compared with desired values and deviations from the desired values are used by the plant control to influence a heat take-up from the impregnated melt by the cooler or coolers.

These and other objects and advantages of the invention will become more apparent from the following detailed description taken in conjunction with the accompanying drawings wherein:

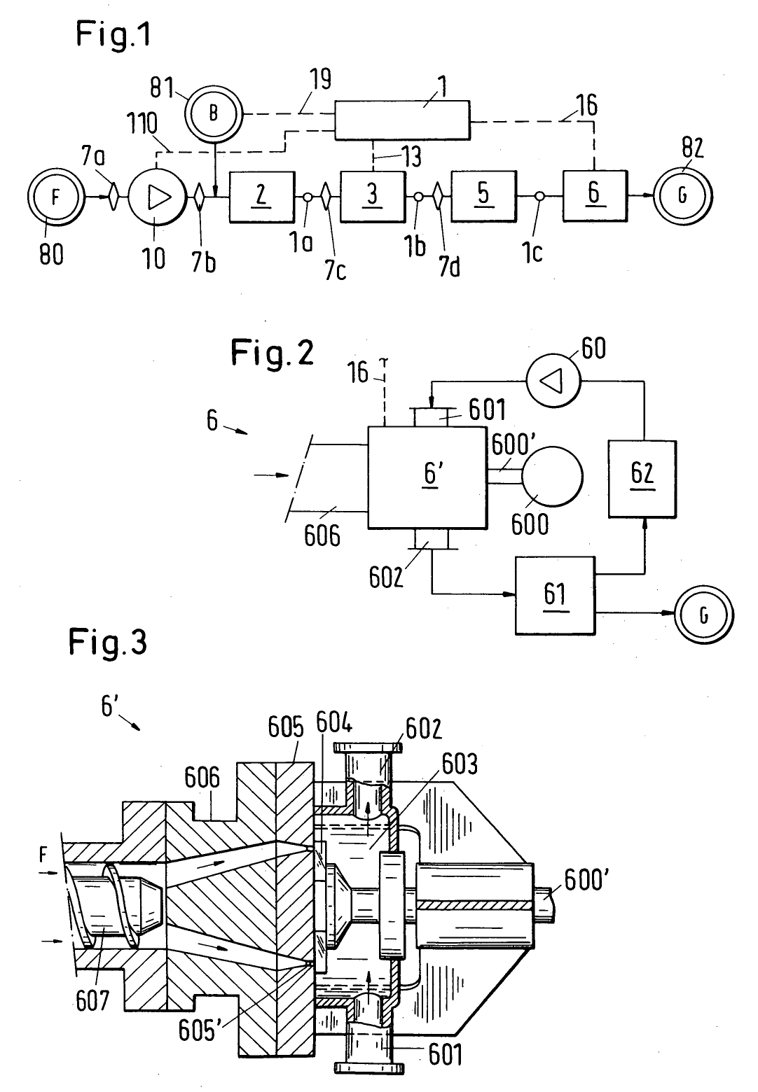

FIG. 1 illustrates a schematic illustration of a plant in accordance with the invention;

FIG. 2 illustrates a detailed illustration of the underwater granulator of FIG. 1;

FIG. 3 illustrates a part cross-sectional view of the underwater granulator; and

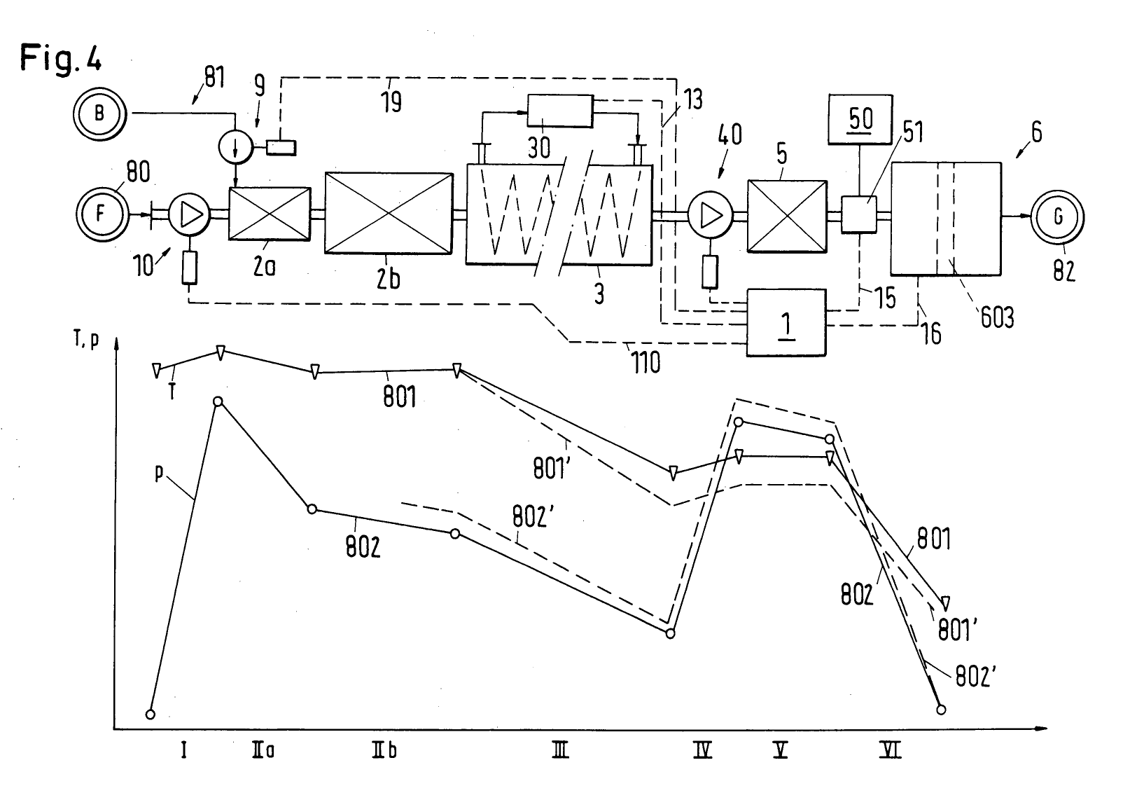

FIG. 4 illustrates a detailed schematic illustration of a realised plant in accordance with the invention and also a diagram with a qualitatively shown plot of temperature and pressure which the melt assumes while flowing through the plant.

Referring to FIG. 1, the plant for the continuous manufacture of expandable plastic granulate G is schematically illustrated. In this arrangement, a first means 80 is provided for supplying a flow of polymer melt F and a second means 81 is provided for delivering an expanding agent B (Blowing Agent) for impregnation into the polymer melt F using a metering apparatus 9.

The plant also includes at least one pressure producing feed apparatus 10 with which the melt F obtained from the first means(source) 80 is volumetrically fed.

The plant has a homogenizing apparatus 2 including a static mixer for homogenizing the expanding agent within the polymer melt F to form a homogeneous mass; a cooler 3 downstream of the homogenizing apparatus 2 to receive and cool the homogeneous mass; a further homogenizing apparatus 5 and an underwater granulator 6 downstream of the cooler 3 to receive the cooled homogeneous mass.

The plant also has a plant control 1 operatively connected as indicated to the metering apparatus 9, pump 10, and cooler 6.

The granulate G which has been produced is ultimately available as a product in a container 82.

The means for supplying the polymer 80 can consist of a polymerisation reactor for the manufacture of the plastic from a monomer source material and also a degasification apparatus for the polymer. The means 80 can also be a recycling apparatus for recycled thermoplastic of one type and also includes a melting apparatus, in particular a heatable extruder. The supply means 80 can also simply be a melting apparatus in which a granular thermoplastic is liquefied.

The granulation is carried out using a liquid (preferably water, for example also a brine or a sols) which is used in the granulator 6 as a cooling and transport medium for the granulate. An elevated pressure is exerted with the liquid used during granulation, due to which the expanding action of the expanding agent in the not-yet solidified granules is suppressed, at least in part.

The regulation of the parameters to be adjusted for the granulation at the inlet of the granulator 6, namely the temperature and the pressure of the impregnated melt, is effected using the plant control 1. In this regulation, measurements of the named parameters are made and also measurement values are compared with desired values. Deviations from the desired values are used to influence a heat take-up from the impregnated melt by the cooler or coolers 3.

The parameters to be adjusted for the granulation are regulated with electronic means using the plant control 1. These means have signal-transmitting connections 19, 110, 13 and 16 to the expanding agent source 81 (metering pump 9), to the feed apparatus 10, to the cooler 3 (or to a plurality of coolers) and to the granulator 6 respectively.

The following adjustable parameters are relevant for the impregnation: temperature, pressure and dwell time. The required dwell time depends on the amount of expanding agent B provided for impregnation. A fixed ratio of expanding agent flow to melt flow is set by means of the plant control 1 for each pre-determined proportion of expanding agent B. These flows, which can be variable, are produced by volumetric feeding. The parameters of temperature and pressure at the inlet of the granulator 6 are relevant for the granulation.

At least one additive can be added before, during and/or after the impregnation of the melt F. Points for the feeding in of additives are shown by FIG. 1 with rhombuses 7a, 7b, 7c and 7d.

The feed apparatus 10 is advantageously a gear pump, however it can also be an extruder. Further feed apparatuses (pumps, extruders, screw conveyers) can be used in the plant in accordance with the invention. Possible points for additional feed apparatuses are shown in FIG. 1 as small circles 1a, 1b and 1c.

The manner of operation of the underwater granulator 6 is described with the help of FIGS. 2 and 3 (see DE-A-35 41 500). The impregnated melt F is granulated in a mechanical apparatus 6′ driven by a motor 600. The homogeneous mass of polymer and expanding agent first passes through a distributor 606 (which forms the inlet of the granulator 6) to a nozzle plate 605, with the melt being extruded through the nozzles 605′ of the nozzle plate. An additional feed means at the inlet, namely a screw conveyor 607, is optional.

The plurality of nozzles 605′ are arranged in ring-like manner on the nozzle plate 605. The plastic strands escaping from the nozzles 605′ enter a chamber 603 filled with water (or with another liquid) where the extruded material is brought into the form of granulate by a comminution with rotating knives 604. The knives 604 sit on a holder which is arranged on a shaft 600′ leading to the motor 600. The water is directed by a pump 60 through an inlet connection 601 under an elevated pressure (for example 10 bar) into the chamber 603 from which the water flushes the granulate, with simultaneous cooling of the granulate G, into a separating apparatus 61 via outlet stubs 602. The granulate G is separated from water in the separating apparatus 61 and discharged into the container 82.

The water flows through a cooling apparatus 62 in which the water gives off the heat taken up from the freshly produced granulate G into the environment. If the water pressure in the separating apparatus 61 is reduced to ambient pressure, then the water pump 60 is arranged upstream before the cooling apparatus 62. If a brine is used instead of water for example, the cooling of the granulate G can be carried out at lower temperatures (<0° C. for example).

In order that the instability problems with the nozzle plate 605 mentioned at the beginning of this specification can be mastered, care has to be taken, on the one hand, that the temperatures (temperature fields) are the same for all nozzles. This takes place with thermostats (not shown). On the other hand, the melt F has to assume a temperature in the distributor 606, the value of which has to be adjusted relative to the operating condition of the plant. The pressure results by means of the fall in pressure along the nozzles 605′ and the water pressure in the chamber 603. The fall in pressure depends on the mass flow rate of the treated melts and on the viscosity of the melts which has a considerable temperature dependence.

The temperature T and the pressure p in the distributor 606 are influenced by the plant control 1 to such an extent that these parameters assume values that are as close as possible to the desired values. The desired values depend on the operating condition and can be presented as mathematical functions or in the form of value tables; they can be determined by means of pilot tests.

FIG. 4 shows, in a detailed schematic illustration, a plant in accordance with the invention which has been realised and with which EPS (expandable polystyrene) can be manufactured. A diagram is associated with the same FIG. 4 in which the plot of temperature T and pressure p which the melt adopts on flowing through the plant is shown in correspondence to the plant illustrated in the upper part. In distinction to FIG. 1, the metering pump 9 for the expanding agent B is shown in FIG. 4. As a further difference, the contacting and homogenisation apparatus 2 is also composed of two static mixers 2a and 2b arranged in series. The intervals IIa and IIb correspond to these mixers 2a and 2b in the diagram. The first interval I corresponds to the pump 10 (gear pump). The cooler 3—corresponding to the interval III—additionally has a cooling apparatus 30 which circulates a heat transfer medium (thermo oil) in a circuit and gives off the heat taken up in the cooler 3 to a heat sink. In the realised plant, the cooler is made of three static mixers (not illustrated) the mixing elements of which are formed as heat exchanger pipes 3′. The interval IV in the diagram corresponds to a second pump 40 which is followed by a static mixer 5 (interval V). A controllable three-way valve 51 which is connected to the plant control 1 (signal line 15) is arranged between the mixer 5 and the granulator 6 (interval VI). Using this when required—this is the case when starting up the plant—melt F can be redirected into an intermediate storage 50. The liquid-filled chamber 603 is indicated in the granulator 6. The signal transmitting connections 19, 110, 13 and 16 have already been described with reference to FIG. 1.

Using the two static mixer, a dispersing of the expanding agent B in the melt F and a dynamic holding of the mixture in a pre-determined pressure range and during a dwell time are respectively carried out, with the dwell time having to be greater than a minimum time span. The dispersing occurs by means of static mixing elements at a high shearing of the melt F with fine expanding agent drops being formed. In the subsequent stage of the second mixer 2b the mixture is exposed to a small shearing action, i.e. the mixture is held dynamically. In this arrangement the expanding agent drops dissolve in the melt F. The shearing has to be so large in this arrangement that no de-mixing occurs. In order for the shearing action in the second impregnation stage to be smaller, the second static mixer 2b has a cross-section through which flow takes place which is greater than a corresponding cross-section of the first static mixer 2a.

In the diagram, the curve 801 shows the melt temperature T as a line drawn through points. The line elements connect the temperature values, which can be respectively measured at the transitions between adjacent plant components and which are illustrated as triangles. In the intervals I, IIa and IIb the temperature is about 220° C. The curve 802 shows the course of the melt pressure p. The values of the pressure p illustrated by circles correspond to the temperature values illustrated with triangles. Using the pump 10, the pressure p is increased to over 200 bar. The dynamic holding of the melt F in the second static mixer 2b (interval IIb of the diagram) takes place at a falling pressure p from approximately 100 to 80 bar.

The plant control 1 causes the heat take-up from the impregnated melt to be influenced by the cooler or coolers 3 by means of the regulation in accordance with the invention. The curve 801′ shown as a broken line shows an altered course of the curve which is to be expected with increased cooling power. Since the viscosity of the melt increases when the temperature is lowered, a greater fall in pressure occurs downstream following the cooling. The pressure curve is correspondingly displaced upwards: dotted curve 802′. Since the pump 10 pumps volumetrically, the pressure increases when the flow resistance increases due to a larger viscosity. In the case of an alteration in operation, the temperature T and the pressure p have to be adapted at the granulator 6. Alterations in operation are: starting up the plant; alteration of the quality of the infed melt F; alteration of the feed quantity (rate); alteration of the proportion of expanding agent; alteration of the composition of the additive. In the case of alterations such as these, the regulation has to become active by means of the plant control 1. Once a steady state operating condition has been reached, then the control is only necessary with regard to disturbing influences from the environment.

Apart from polystyrene, another thermoplastic can also be used as a plastic. Examples are: styrene-copolymers, polyolefines, in particular polyethylene and also polypropylene or a mixture of these named substances. H₂O, CO₂, N₂, a low boiling hydrocarbon, in particular pentane, or a mixture of the named substances can be used as an expanding agent. Diverse forms of granulate can be produced (depending on the cross-section of the nozzles 605′, on the rotational speed of the knives 604 and on the water pressure in the chamber 603). In particular, the granulate can be produced in the form of “pellets” or “beads” or as a partially foamed granulate.

The invention thus provides a method and plant for the continuous manufacture of expandable plastic granulate wherein the nozzles of a granulator are prevented form clogging.

What is claimed is:

1. A method for the continuous manufacture of expandable plastic granulate comprising the steps of
impregnating of a plastic melt with a fluid expanding agent to form a homogeneous mass;
cooling the homogeneous mass;
passing the cooled homogeneous mass into a granulator having a plurality of nozzles for passage of the homogeneous mass therethrough to form a plurality of strands of the homogeneous mass, a comminuting device for comminuting the plurality of strands into granules and a chamber for receiving the granules and a flow of coolant for cooling the granules; and
maintaining the pressure of the homogeneous mass received in the granulator in a predetermined range and the temperature of the homogeneous mass received in the granulator in a predetermined range to prevent solidification of the homogeneous mass and clogging of the nozzles.

2. A method as set forth in claim 1 further comprising the steps of metering the flow of fluid expanding agent into the homogeneous mass at a rate to maintain the pressure of the homogeneous mass received in the granulator in said predetermined range.

3. A method as set forth in claim 1 further comprising the steps of dispersing the fluid expanding agent in the plastic melt under a strong shearing action in a first static mixer and of thereafter holding the resulting mixture dynamically within a predetermined pressure range and dwell time within a second static mixer.

4. A method as set forth in claim 1 wherein the plastic melt is selected form the group consisting of polystyrene, styrene-copolymers, polyolefins, polypropylene and mixtures thereof and the expanding agent is selected from the group consisting of water, carbon dioxide, nitrogen, a low boiling hydrocarbon and mixtures thereof.

5. A method as set forth in claim 1 further comprising the step of adding at least one additive to the homogeneous mass.

6. A method as set forth in claim 1 further comprising the step of comminuting the strands into at least one of a bead, a pellet and a partially expended granule.

7. A plant for the continuous manufacture of expandable plastic granulate comprising
first means for supplying a flow of polymer melt;
second means for impregnating the flow of polymer melt with an expanding agent;
a homogenizing apparatus including at least one static mixer for homogenizing the expanding agent within the polymer melt to form a homogeneous mass;
a cooler downstream of said homogenizing apparatus to receive and cool the homogeneous mass;
a granulator downstream of said cooler to receive the cooled homogeneous mass, said granulator having a plurality of nozzles for passage of the homogeneous mass therethrough to form a plurality of strands of the homogeneous mass, a comminuting device for comminuting the plurality of strands into granules and a chamber for receiving the granules and a flow of coolant for cooling the granules; and
an electronic plant control operatively connected to each of said first means, said second means, said cooler and said granulator to maintain the pressure of said homogeneous mass received in said granulator in a predetermined range and the temperature of said homogeneous mass received in said granulator in a predetermined range to prevent solidification of the homogeneous mass and to prevent clogging of said nozzles.

8. A plant as set forth in claim 7 wherein said first means is one of a pump and an extruder.

9. A plant as set forth in claim 7 wherein said second means is a metering pump.

10. A plant as set forth in claim 7 wherein said cooler includes at least one static mixer for mixing the received homogeneous mass.

11. A plant as set forth in claim 7 further comprising a pump between said cooler and said granulator for pumping the homogeneous mass into said granulator at a predetermined pressure, said electronic plant control being operatively connected with said pump to regulate the pressure of the homogeneous mass passing through said pump and a static mixer between said pump and said granulator for mixing the homogeneous mass delivered to said granulator.

12. A plant as set forth in claim 7 further comprising a pair of static mixers disposed in series between said second means and said cooler, a first of said pair of static mixers having mixing elements to create greater shearing effects than in the other of said pair of static mixers, said other static mixer having a flow cross-section larger than a corresponding cross-section of said first static mixer.
